(19) United States
(12) Patent Application Publication
(10) Pub. No.: US 2026/0356142 A1
(43) Pub. Date: Nov. 12, 2026

(54) RETRACTABLE TRAILER HITCH SYSTEMS AND METHODS

(71) Applicant: RoboHitch, LLC, Tucson, AZ (US)

(72) Inventor: Faisal Adil, Tucson, AZ (US)

(73) Assignee: RoboHitch, LLC, Tucson, AZ (US)

(21) Appl. No.: 19/672,474

(22) Filed: May 8, 2026

Related U.S. Application Data
(60) Provisional application No. 63/803,468, filed on May 9, 2025.

(51) Int. Cl. B60D 1/44; B60D 1/06; B60D 1/40

(52) U.S. Cl. CPC B60D 1/44; B60D 1/06; B60D 1/40

(57) ABSTRACT

A hitch system can include a ball hitch and an actuator. The actuator can be operated to cause the ball hitch to extend and retract. The ball hitch can include a ball mount and a shank. The hitch system can further include a sleeve configured to telescopingly receive at least a portion of the shank. In this manner, a position of the ball hitch can be adjusted with respect to a towing vehicle for “fine tuning” a position of the ball hitch when coupling, decoupling, and/or moving a towed vehicle (e.g., a trailer).

### CROSS REFERENCE TO RELATED APPLICATIONS

This application claims priority to, and the benefit of, U.S. Provisional Patent Application Serial No. 63/803,468, entitled “RETRACTABLE TRAILER HITCH SYSTEMS AND METHODS,” filed on May 9, 2025. The ‘468 Application is hereby incorporated by reference in its entirety for all purposes.

### FIELD

The present disclosure relates generally to trailer hitch systems, and more particularly, but not necessarily entirely, to trailer hitch systems that facilitate connecting trailers to tow vehicles.

### BACKGROUND

Various different types of trailer hitches are known in the art for attaching trailers to towing vehicles. One of the most common types of towing systems utilizes a ball hitch. Typical ball hitches have a generally spherical shaped ball with a stem or threaded rod extending from a base of the ball. The threaded rod may be configured to engage a hitch head mounted on the towing vehicle using a threaded receiver or ball hitch fitting. A trailer coupling member, such as a ball clamp, positioned on a front of the trailer tongue, may engage the ball hitch in a loose friction fit, and may be secured to the ball in preparation for towing. Some hitches may also have load equalizing systems to distribute loads and allow the towing vehicle and trailer to remain level. Other mechanisms may also be used in association with a trailer hitch to reduce side sway of the trailer.

A common challenge with the known trailer hitch systems is attaching the trailer to the tow vehicle. Difficulty may arise in properly aligning the trailer with the tow vehicle as the tow vehicle is backed to engage with the trailer. During some attempts to attach the trailer to the tow vehicle, the sharp rigid end of the trailer tongue may strike the back of the tow vehicle causing damage to the tow vehicle.

Another challenge with the known trailer hitch systems is parking the trailer while the trailer is attached to the vehicle, particularly in tight spaces. Difficultly may arise in properly aligning the trailer and/or estimating how far the trailer is from adjacent features (e.g., other vehicles, adjacent structures such as a wall, etc.).

### SUMMARY

Various aspects of the subject matter described in this disclosure may be embodied in a hitch system. The hitch system can include a ball hitch including a ball mount and a shank. The hitch system can include a sleeve configured to receive at least a portion of the shank. The sleeve can be configured to be mounted to a towing vehicle. The hitch system can include an actuator coupled between the sleeve and the ball hitch, wherein the actuator is configured to cause the ball hitch to move between an extended position with respect to the sleeve and a retracted position with respect to the sleeve.

In various aspects, the shank comprises a shank aperture and the sleeve comprises a sleeve aperture, and the shank aperture is configured to align with the sleeve aperture to receive a locking pin therethrough for locking the ball hitch to the sleeve.

In various aspects, the hitch system further comprises a hitch mount coupled to the sleeve, whereby the sleeve is configured to be mounted to the towing vehicle. In various aspects, the hitch mount comprises an elongated square tube. In various aspects, the hitch system further comprises a connecting member extending between and to the hitch mount whereby the sleeve is secured to the hitch mount.

In various aspects, the hitch system further comprises a clamp member configured to be coupled around the sleeve and the hitch mount for supporting the sleeve relative to the hitch mount.

In various aspects, the hitch system further comprises a first flange extending from the sleeve and a second flange extending from the ball hitch, and the actuator extends between and to the first flange and the second flange, and the actuator is a linear actuator.

In various aspects, the shank comprises a plurality of shank apertures and the sleeve comprises a sleeve aperture, and the sleeve aperture is configured to align with each shank aperture of the plurality of shank apertures depending on a position of the ball hitch with respect to the sleeve.

In various aspects, the sleeve comprises a plurality of sleeve apertures and the shank comprises a shank aperture, and the shank aperture is configured to align with each sleeve aperture of the plurality of sleeve apertures depending on a position of the ball hitch with respect to the sleeve.

Various aspects of the subject matter described in this disclosure may be embodied in a vehicle. The vehicle can include a hitch receiver, a ball hitch including a ball mount and a shank, and an actuator coupled between the hitch receiver and the ball hitch, wherein the actuator is configured to cause the ball hitch to move between an extended position with respect to the hitch receiver and a retracted position with respect to the hitch receiver.

In various aspects, the vehicle further comprises a sleeve configured to receive at least a portion of the shank, the sleeve is configured to be mounted to the hitch receiver. In various aspects, the shank comprises a shank aperture and the sleeve comprises a sleeve aperture, and the shank aperture is configured to align with the sleeve aperture to receive a locking pin therethrough for locking the ball hitch to the sleeve. In various aspects, the vehicle further comprises a hitch mount coupled to the sleeve, the hitch mount is configured to be received in the hitch receiver for mounting the sleeve to the vehicle. In various aspects, the vehicle further comprises a connecting member extending between and to the hitch mount whereby the sleeve is secured to the hitch mount. In various aspects, the vehicle further comprises a clamp member configured to be coupled around the sleeve and the hitch mount for supporting the sleeve relative to the hitch mount. In various aspects, the sleeve is disposed beneath the hitch receiver. In various aspects, the vehicle further comprises a chain aperture disposed in the connecting member, the connecting member is configured to be connected to a safety chain of a towed vehicle at the chain aperture.

Various aspects of the subject matter described in this disclosure may be embodied in a method. The method can be for operating a hitch system. The method can include operating an actuator to move from a first position to a second position. The method can include moving a ball hitch with the actuator in an aft direction away from a towing vehicle in response to the actuator moving from the first position to the second position.

In various aspects, the method further includes operating the actuator to move from the second position to the first position. In various aspects, the method further includes moving the ball hitch with the actuator in response to the actuator moving from the second position to the first position, wherein the ball hitch moves in a forward direction toward the towing vehicle in response to the ball hitch moving. In various aspects, the method further includes moving a locking pin to extend through a shank aperture of a shank of the ball hitch for locking the ball hitch in position.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A is side, assembly view of a retractable trailer hitch system between a towing vehicle and a trailer, in accordance with various examples.

FIG. 1B is a side view of the retractable trailer hitch system of FIG. 1A installed on the towing vehicle, in accordance with various examples.

FIG. 1C is a side view of the retractable trailer hitch system of FIG. 1B in an extended position, in accordance with various examples.

FIG. 2A is a right perspective view of a retractable trailer hitch system, in accordance with various examples.

FIG. 2B is a left perspective view of the retractable trailer hitch system of FIG. 2A, in accordance with various examples.

FIG. 2C is a side view of the retractable trailer hitch system of FIG. 2A, in accordance with various examples.

FIG. 2D is a top view of the retractable trailer hitch system of FIG. 2A, in accordance with various examples.

FIG. 2E is a front view of the retractable trailer hitch system of FIG. 2A, in accordance with various examples.

FIG. 3A is a side view of a retractable trailer hitch system, in accordance with various examples.

FIG. 3B is a top view of the retractable trailer hitch system of FIG. 3A, in accordance with various examples.

FIG. 3C is a front view of the retractable trailer hitch system of FIG. 3A, in accordance with various examples.

FIG. 4A is a side view of a retractable trailer hitch system installed on a towing vehicle, in accordance with various examples.

FIG. 4B is a side view of the retractable trailer hitch system of FIG. 4A in an extended position, in accordance with various examples.

FIG. 5 is a perspective view of a retractable trailer hitch system, in accordance with various examples.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein. Thus, the detailed description herein is presented for purposes of illustration only and not of limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step.

A retractable trailer hitch system can include a hitch (e.g., described herein with respect to a ball hitch, though other types of hitches can be used) configured to move between an extended position and a retracted position. The trailer hitch system generally includes the hitch (e.g., a ball hitch) and an actuator for extending and retracting the hitch. The actuator can be operated for moving (e.g., extending and/or retracting) the hitch with respect to a vehicle received and/or a sleeve so as to position the hitch at a desired position to assist in attaching a trailer to the towing vehicle or to position the trailer (coupled to the hitch) at a desired position with respect to a stopped towing vehicle.

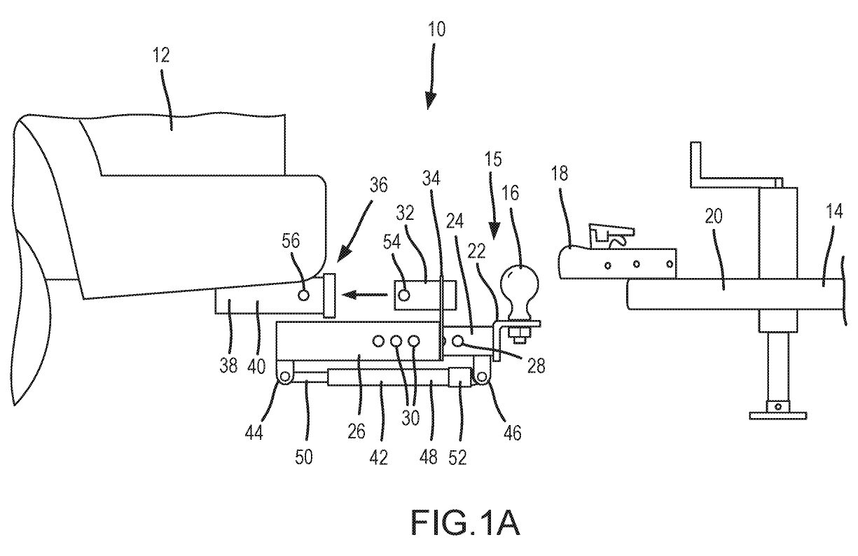

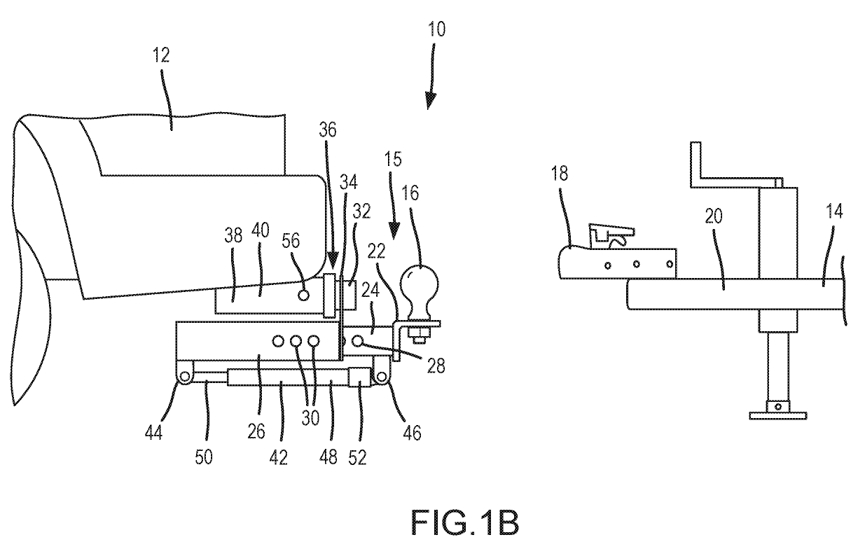

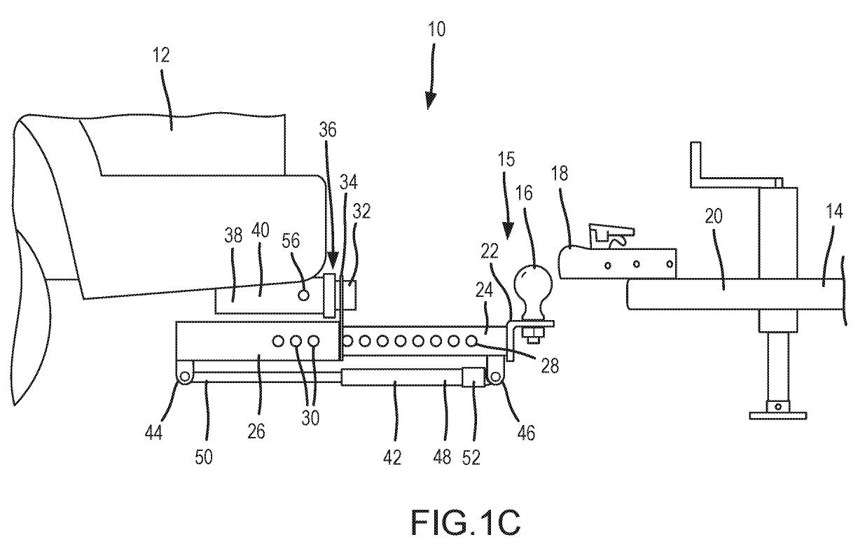

Referring now to FIG. 1A, an exploded side view of a trailer hitch system is shown indicated generally at 10 in accordance with the principles of the present disclosure. The trailer hitch system 10 is shown in FIG. 1A on a towing vehicle 12 and a trailer 14. It will be understood that the towing vehicle 12 may be any variety of vehicle known in the art, such as a truck, tractor, or car, or any other variety of on-road or off-road vehicle, for example. Likewise, the principles of the present disclosure may be utilized with any variety of trailer 14 known in the art, such as camping trailers, boat trailers, or cargo trailers, for example.

The hitch system 10 can include a ball hitch 15 including a ball 16 for attaching to a ball socket 18 on a tongue 20 of the trailer 14. It will be understood that the hitch system 10 can be versatile, as explained more fully below, to allow the ball hitch 15 to extend and retract from the towing vehicle 12. Although described herein as a ball hitch 15, the hitch system 10 can include any suitable trailer coupling, such as a pintle hitch for example.

The ball 16 can be attached to a ball mount 22 in any suitable manner. For example, the ball 16 can be formed with a stem that may be received in the ball mount 22 and a nut may be threaded on the stem to hold the ball 16 on the ball mount 22. Accordingly, it will be understood that a ball 16 may be interchangeable, and a ball 16 of various different sizes and configurations compatible with the socket 18 may be used. It will be understood that the ball 16 may be attached to the ball mount 22 in any other suitable manner known to those skilled in the art.

A shank 24 can be joined to the ball mount 22 for attaching the ball mount 22 to a sleeve 26. The shank 24 can be a telescoping shank configured to extend from, and retract into, the sleeve 26. The sleeve 26 can include a receptacle configured for receiving the shank 24. The receptacle can have a wall forming the sleeve 26 for receiving the shank 24. In various aspects, the sleeve 26 can be formed in a substantially square cross-sectional shape for receiving a correspondingly shaped portion of the shank 24. Accordingly, the sleeve 26 can be configured to circumscribe a portion of the shank 24. However, it will be understood that the sleeve 26 can have any other suitable shape, such as round, polygonal, rectangular, or oval, for example, corresponding to the shape of the shank 24 within the scope of the present disclosure. Moreover, various embodiments of the sleeve 26 can only partially circumscribe the shank 24.

A first end of the shank 24 can be received into the sleeve 26 and a second end of the shank 24 can be attached to the ball mount 22. The sleeve 26 can form an elongate member extending in a direction transverse to the ball 16. The sleeve 26 can form an elongate hollow member such as a square tube, a rectangular tube, or the like. The shank 24 can form an elongate member extending substantially parallel to the sleeve 26. The elongate member can define a central axis that can extend in a direction between the trailer 14 and the tow vehicle 12. The shank 24 can be positioned concentric with the sleeve 26. The shank 24 can form an elongate member such as a square tube, a square rod, or the like. In this regard the shank 24 can be solid or can be hollow, in accordance with various examples.

In various aspects, the shank 24 can be adjustably secured in position with respect to the sleeve 26 through one or more shank openings 28. The openings 28 can be disposed along a length of the shank 24 such that the openings 28 can correspond to sleeve openings 30. It will be understood that the shank 24 can be movable with respect to the sleeve 26 such that the shank openings 28 align with a desired sleeve opening 30 to position the shank 24 at the desired position. Bolts, pins, clips, or the like may be used (e.g., positioned through a sleeve opening 30 and a corresponding shank opening 28) to fasten the shank 24 at a desired position with respect to the sleeve 26.

The hitch system 10 can further include a hitch mount 32 for attaching the sleeve 26 to the towing vehicle 12. The hitch mount 32 can form an elongate member extending in a direction transverse to the ball 16. The hitch mount 32 can form an elongate member such as a square tube, a square rod, or the like. The hitch mount 32 can form an elongate member extending substantially parallel to the sleeve 26. The elongate member can define a central axis that can extend in a direction between the trailer 14 and the tow vehicle 12. The hitch mount 32 can be solid or can be hollow, in accordance with various examples. In various aspects, the hitch mount 32 can be formed from a metallic material, including ferrous metals such as carbon steel, stainless steel, or alloy steel, or non-ferrous metals such as aluminum, aluminum alloys, copper, or brass; or from a polymeric material, including thermoplastics such as polyethylene, polypropylene, or nylon, or thermosets such as epoxy or polyurethane; or from a composite material, including fiber-reinforced polymers such as fiberglass or carbon fiber reinforced polymer. The hitch mount 32 can be coupled to the sleeve 26 via a connecting member 34. In various aspects, the connecting member 34 can be a plate. The plate can extend in a direction transverse to the hitch mount 32 and the sleeve 26. In various aspects, the connecting member 34 can be coupled to the hitch mount 32 and/or the sleeve 26 via a joining process, such as a metallic joining process including welding (e.g., MIG welding, TIG welding, spot welding, or arc welding), soldering, or brazing, or via a mechanical fastening process including bolting, riveting, or press-fitting, or via an adhesive bonding process including structural adhesives such as epoxy adhesives or polyurethane adhesives.

The hitch mount 32 can be configured to be received into a receiver 36 of the tow vehicle 12 for attaching to the tow vehicle 12. The receiver 36 can include a receptacle 38 configured for receiving the hitch mount 32. The receptacle 38 can have a wall 40 forming a sleeve for receiving the hitch mount 32. The receptacle 38 can be formed in a substantially square cross-sectional shape for receiving a correspondingly shaped portion of the hitch mount 32. Accordingly, the receptacle 38 can be configured to circumscribe a portion of the hitch mount 32. However, it will be understood that the receptacle 38 may have any other suitable shape, such as round, polygonal, rectangular, or oval, for example, corresponding to the shape of the hitch mount 32 within the scope of the present disclosure. Moreover, in various embodiments, the receptacle 38 may only partially circumscribe the hitch mount 32. It will also be understood that various embodiments of the receiver 36 may be a conventional receiver that may be installed on the tow vehicle 12 at the manufacturer, or as an accessory. Accordingly, the term “receiver” as used herein shall be construed broadly to include various different types of structures for receiving or joining the hitch mount 32 with a tow vehicle 12.

The hitch system 10 can further include an actuator 42 coupled between the sleeve 26 and the ball hitch 15. For example, a first coupler 44 can extend from the sleeve 26. A first end of the actuator 42 can be coupled to the first coupler 44. A second coupler 46 can extend from the ball hitch 15. The second coupler 46 can extend from the shank 24 and/or the ball mount 22. A second end of the actuator 42 can be coupled to the second coupler 46. The first coupler 44 and/or the second coupler 46 can include a flange or a pair of flanges whereby the actuator 42 is connected to the sleeve 26 and/or the shank 24, respectively.

The actuator 42 can be a linear actuator. The actuator 42 can include a first portion 48 and a second portion 50 telescopingly coupled with the first portion 48. For example, the second portion 50 can extend and retract with respect to the first portion 48. The actuator 42 can include a motor 52 that moves the second portion 50 with respect to the first portion 48. The actuator 42 can be an electromechanical linear actuator that converts rotary motion into linear motion. In various aspects, the motor 52 can be a DC motor, a stepper motor, a servo motor, or a brushless DC motor. The motor 52 can be operated to rotate in a first rotational direction to cause the shank 24 to extend from the sleeve 26 and can be operated to rotate in a second rotational direction (opposite the first rotational direction) to cause the shank 24 to retract into the sleeve 26. The actuator 42 can include a ball screw driven stage, a lead screw driven stage, an XY stage, a motorized stage, a motor driven stage, a linear stage, and/or a crossed roller stage. In various aspects, the actuator 42 can include a rack and pinion mechanism, a belt drive mechanism, or a chain drive mechanism. The actuator 42 can be a pneumatic actuator (e.g., a pneumatic cylinder), a hydraulic actuator (e.g., a hydraulic cylinder), an electric actuator, a piezoelectric actuator, or any other suitable actuator.

In various aspects, the hitch system 10 can further include a controller configured to control operation of the actuator 42. The controller can include a processor and a memory storing instructions that, when executed by the processor, cause the controller to control movement of the actuator 42. The controller can be configured to receive control signals from a user interface, such as a wired control switch, a wireless remote control, a smartphone application, or a vehicle-integrated control panel. In various aspects, the hitch system 10 can include one or more sensors configured to detect a position of the ball hitch 15, such as a limit switch, a proximity sensor, a potentiometer, or an encoder. The controller can be configured to receive position feedback from the one or more sensors and control the actuator 42 based at least in part on the position feedback.

FIG. 1B shows a side view of the trailer hitch system 10 installed onto the towing vehicle 12, in accordance with various aspects. In the installed position, the hitch mount 32 is positioned at least partially in the receiver 36 of the tow vehicle 12. A hitch mount aperture 54 (see FIG. 1A) of the hitch mount 32 can be aligned with a receiver aperture 56 of the receiver 36 in the installed position and, in various aspects, a locking pin can be placed through the apertures 54, 56 to lock the hitch mount 32 to the receiver 36 in the installed position.

FIG. 1C shows a side view of the trailer hitch system 10 installed onto the towing vehicle 12 with the ball hitch 15 moved to an extended position with respect to the sleeve 26. The actuator 42 can be operated to move the ball hitch 15 between the extended position (see FIG. 1C) and a retracted position (see FIG. 1B) with respect to the sleeve 26 and/or the receiver 36. For example, the actuator 42 can extend (i.e., the second portion 50 can extend from the first portion 48) to cause the ball hitch 15 to slidingly extend from the sleeve 26 toward the extended position. Conversely, the actuator 42 can retract (i.e., the second portion 50 can retract into the first portion 48) to cause the ball hitch 15 to slidingly retract into the sleeve 26 toward the retracted position. The ball hitch 15 can extend and retract along a vehicle longitudinal direction (i.e., a rear-front/font-rear direction of the vehicle 12).

In this manner, the ball hitch 15 can be extended from the towing vehicle 12 for connecting the ball 16 (or any other towing mechanism) to a towed vehicle (e.g., the trailer 14). In this manner, the trailer hitch system 10 can be utilized to assist in coupling the ball 16 to the ball socket 18 without having to move the towing vehicle 12 or the trailer 14. Moreover, the trailer hitch system 10 can be operated to extend or retract while the trailer 14 is coupled to the ball hitch 15, for example for fine-tuning a position of the trailer 14. As an example, a watercraft trailer can be caused to extend from the vehicle 12 while launching or trailering a watercraft without having to move the towing vehicle 12 to fine-tune a position of the trailer in a body of water. As another example, a position of a hitched trailer can be fine-tuned in a parking space using the trailer hitch system 10. As another example, a position of a hitched bike carrier can be adjusted using the trailer hitch system 10 to allow opening and/or closing of a tailgate of a vehicle while the bike carrier is installed (e.g., to extend the bikes away from the tailgate to provide clearance for opening and closing thereof).

Having described various aspects of the hitch system 10, a method for operating the hitch system 10 can include operating the actuator 42 to move from a first position (e.g., a retracted position) to a second position (e.g., an extended position). The method can further include moving the ball hitch 15 with respect to the receiver 36 with the actuator 42 in response to the actuator 42 moving from the first position to the second position. The ball hitch 15 can move in an aft direction away from the towing vehicle 12 in response to the ball hitch 15 moving with respect to the receiver 36. The actuator 42 can be operated in an opposite direction to move from the second position back to the first position to move the ball hitch 15 in a forward direction toward the towing vehicle 12.

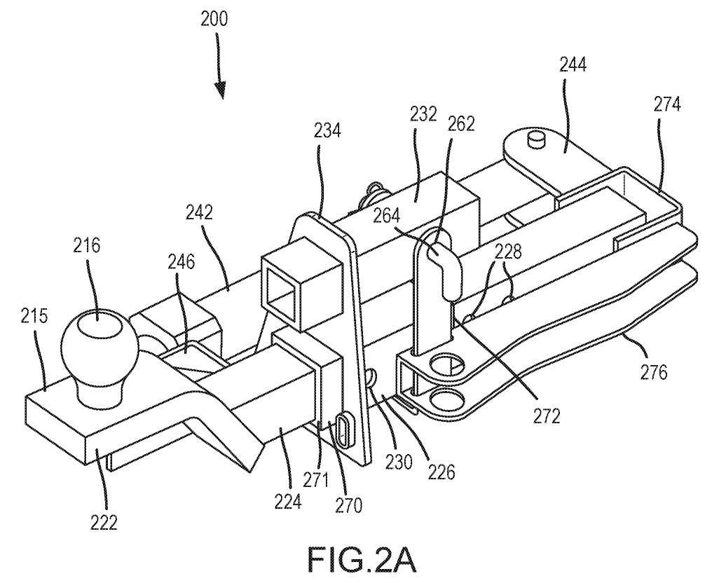

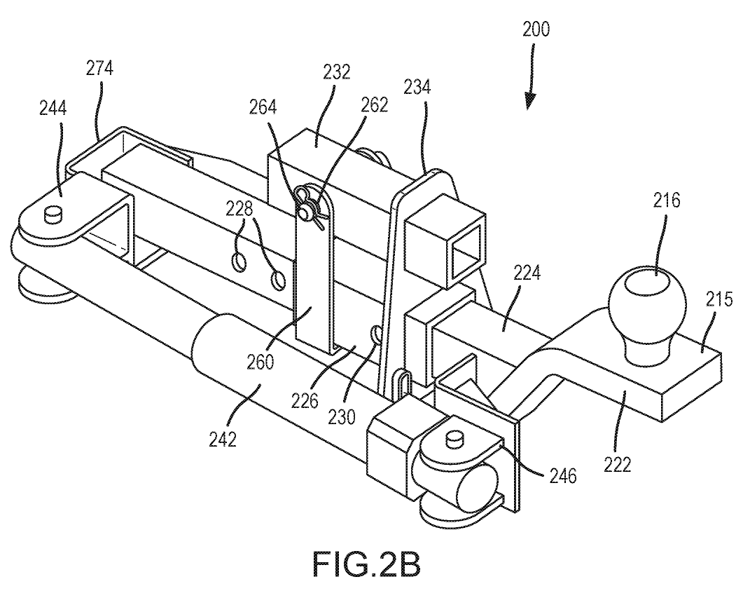

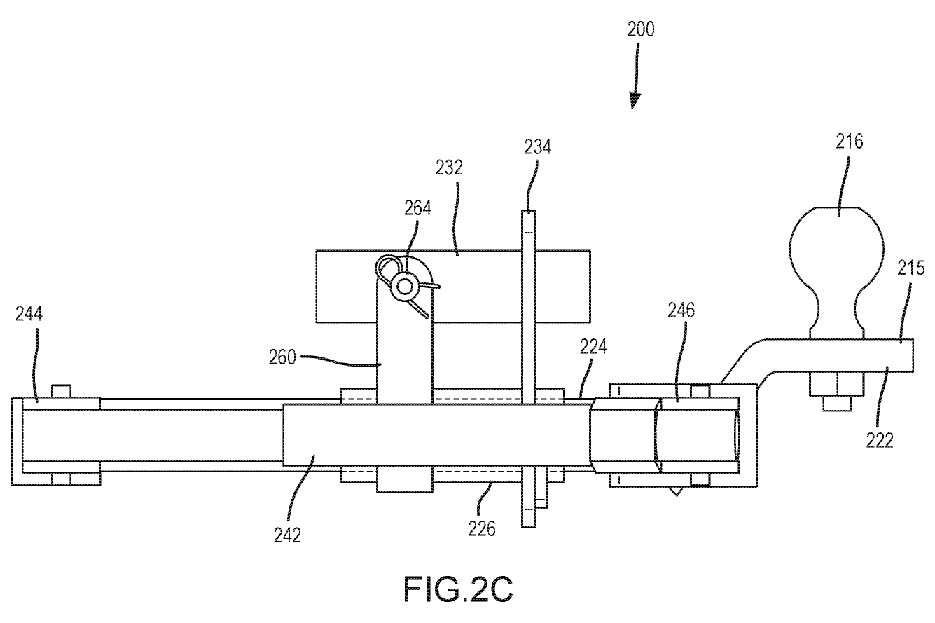

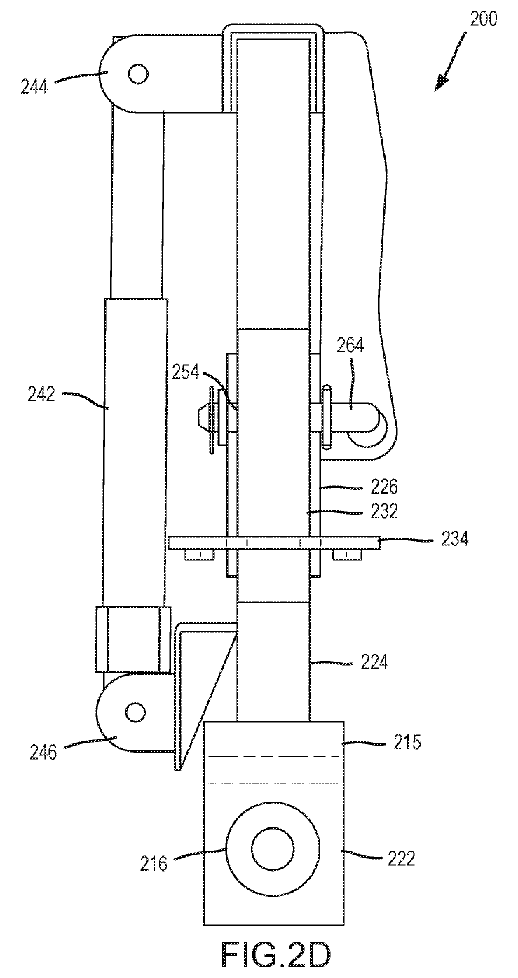

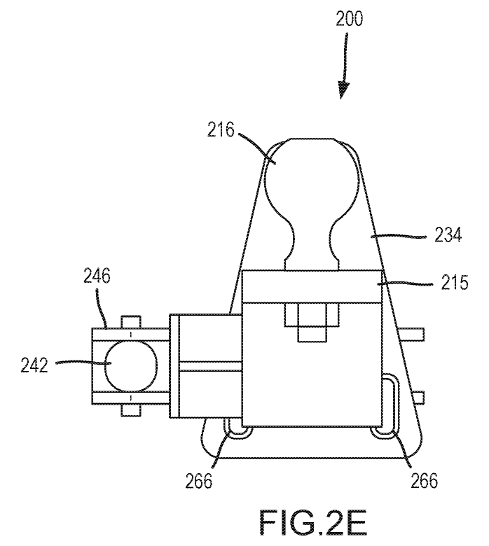

FIGS. 2A and 2B are perspective views of a trailer hitch system 200 shown in accordance with the principles of the present disclosure. The hitch system 200 can be similar to the hitch system 10 described with respect to FIGS. 1A-1C. The hitch system 200 can generally include a ball hitch 215 including a ball 216 for attaching to a ball socket of a trailer tongue. The ball hitch 215 can generally include a ball mount 222, the ball 216 mounted to the ball mount 222, and a shank 224 extending from the ball mount 222. The hitch system 200 can further include a sleeve 226 configured to slidingly receive the shank 224. The sleeve 226 can form an elongate hollow member such as a square tube, a rectangular tube, or the like. The shank 224 can be adjustably secured in position with respect to the sleeve 226 through one or more shank openings 228. The shank 224 can be adjustably secured in position with respect to the sleeve 226 by aligning one of the openings 228 with a sleeve opening 230 disposed in the sleeve 226. A bolt, pin, clip, or the like may be used (e.g., positioned through a sleeve opening 230 and a corresponding shank opening 228) to fasten the shank 224 at a desired position with respect to the sleeve 226.

The hitch system 200 can further include a hitch mount 232 for attaching the sleeve 226 to a towing vehicle. The hitch mount 232 can form an elongate member coupled side-by-side to the sleeve 226. The hitch mount 232 can be an elongate member such as a square tube, a square rod, or the like. The hitch mount 232 can be coupled to the sleeve 226 via a connecting member 234. In various aspects, the connecting member 234 can be a plate. The plate can extend in a direction transverse to the hitch mount 232 and the sleeve 226.

The hitch system 200 can further include an actuator 242 coupled between the sleeve 226 and the ball hitch 215. For example, a first coupler 244 can extend from the sleeve 226. A first end of the actuator 242 can be coupled to the first coupler 244. A second coupler 246 can extend from the ball hitch 215. The second coupler 246 can extend from the shank 224 and/or the ball mount 222. A second end of the actuator 242 can be coupled to the second coupler 246. The first coupler 244 and/or the second coupler 246 can include a flange or a pair of flanges whereby the actuator 242 is connected to the sleeve 226 and/or the shank 224, respectively. The second coupler 246 can extend from a side surface of the ball hitch 215. In this regard, the actuator 242 can be located in a side-by-side configuration adjacent the shank 224 when the hitch system 200 is installed on the tow vehicle.

With reference to FIGS. 2A and 2B, the sleeve 226 can include a tube body 270 including a first end 271 and a second end 272. The shank 224 can be configured to extend through the tube body 270. The sleeve 226 can include an end support 274. The end support 274 can be configured to receive an end of the shank 224. The end support 274 can be coupled to the tube body 270 via a coupling 276. The coupling 276 can be formed as an elongated member for supporting the end support 274 spaced apart from the tube body 270. In various aspects, the coupling 276 can be a metallic plate, including a steel plate or an aluminum plate, or a polymeric plate, or a bar, or a tube, or the like. The coupling 276 can be formed as an elongated U-shaped bracket extend between and to the tube body 270 and the end support 274. The end support 274 can be configured to receive an end of the shank 224 in response to the ball hitch 215 moving to a retracted position. In various aspects, the end support 274 can include a bottom wall, opposing side walls, and a back wall. The first coupler 244 can be mounted to the end support 274.

FIGS. 2C and 2D are side and top views, respectively, of the trailer hitch system 200. The trailer hitch system 200 can further include a clamp member 260 sized and configured to be coupled around the sleeve 226 and the hitch mount 232 for supporting the sleeve 226 relative to the hitch mount 232. The clamp member 260 can be a U-shaped bracket. The clamp member 260 can include two aligned apertures 262 configured to receive a pin 264. The apertures 262 of the clamp member 260 can be aligned with the hitch mount aperture 254 (see FIG. 2D; see also hitch mount aperture 54 of FIG. 1A) and the pin 264 can be positioned through the apertures 262 and the hitch mount aperture 254. In various aspects, the clamp member 260 can extend through the coupling 276.

With reference to FIG. 2C, the connecting member 234 can be located at a first end of the hitch mount 232 (i.e., nearer the first end than to the second end) and the clamp member 260 can be located at a second end of the hitch mount 232 (i.e., nearer the second end than to the first end). The clamp member 260 can extend around the sleeve 226 and extend from the sleeve 226 to the hitch mount 232. The apertures 262 can be disposed at the ends of the clamp member 260. The clamp member 260 can support the sleeve 226 to mitigate movement of the sleeve 226 with respect to the hitch mount 232.

FIG. 2E is a front view of the trailer hitch system 200, in accordance with various aspects. The connecting member 234 can include a pair of apertures 266, each disposed at opposite sides of the ball hitch 215 for connecting trailer safety chains to the connecting member 234.

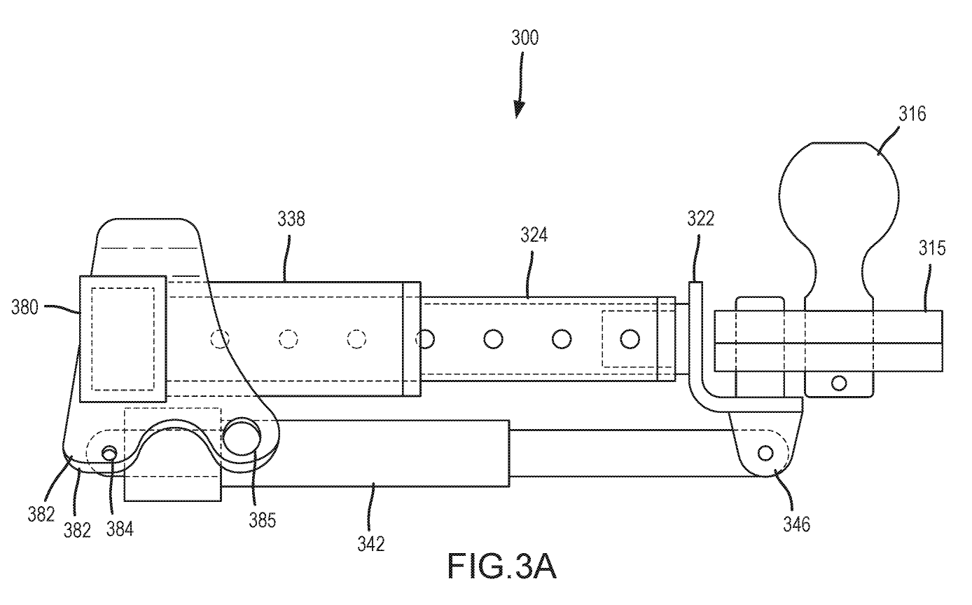

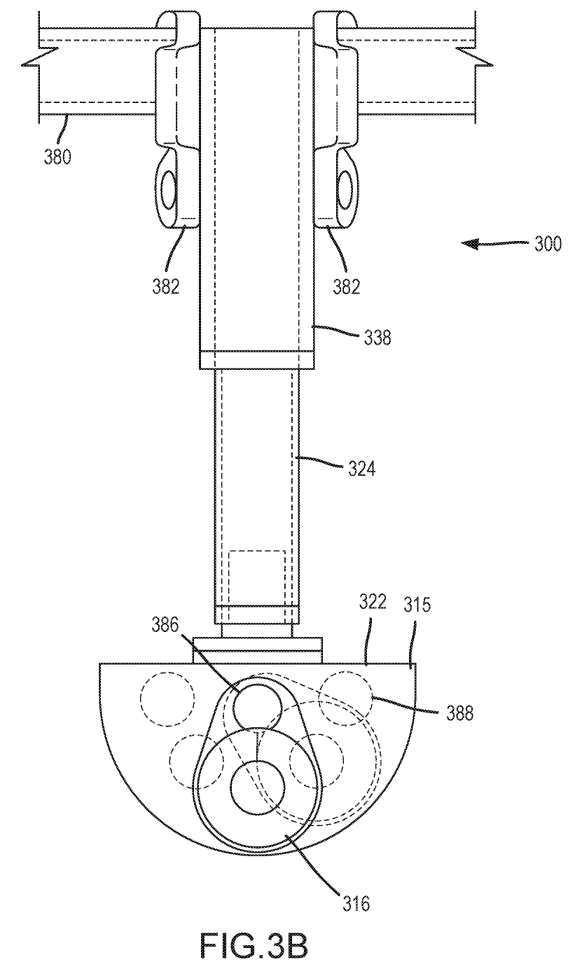

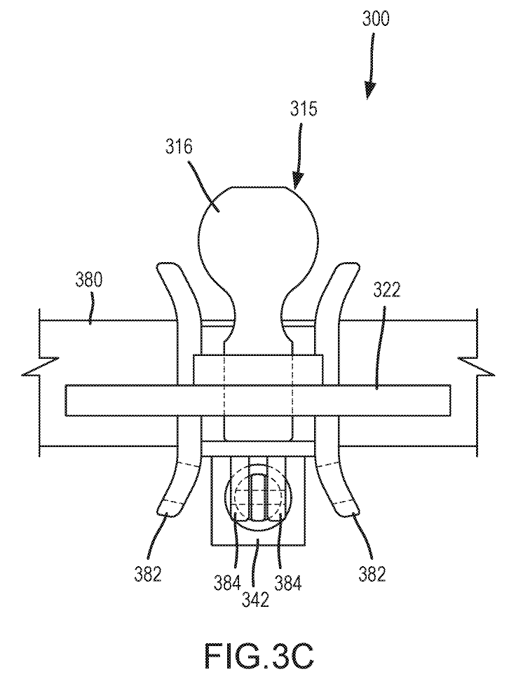

FIGS. 3A, 3B, and 3C are side, top, and front views, respectively, of an example trailer hitch system 300 in accordance with the principles of the present disclosure. The trailer hitch system 300 can be similar to the hitch system 10 described with respect to FIGS. 1A-1C and/or the hitch system 200 described with respect to FIGS. 2A-2E, except that the hitch mount is omitted since the retractable ball hitch is received directly into the hitch receiver 338 of the towing vehicle. For example, the hitch receiver 338 can be supported by a frame 380 of the towing vehicle. One or more brackets 382 can extend from the frame 380 and/or the hitch receiver 338 and form an attachment point 384 for coupling the actuator 342 to the hitch receiver 338. The one or more brackets 382 can further include opposing chain apertures 385 for connecting a safety chain of a trailer coupler to the hitch receiver 338/frame 380.

In various aspects, a second coupler 346 can extend from an underside surface of the ball hitch 315. In this regard, the actuator 342 can be located underneath the shank 324 when the hitch system 300 is installed on the tow vehicle.

With reference to FIG. 3B, a top view of the hitch system 300 is illustrated, in accordance with various aspects. The ball hitch 315 can generally include a ball mount 322, a ball 316 mounted to the ball mount 322, and a shank 324 extending from the ball mount 322. The ball 316 can be pivotally coupled to the ball mount 322. In this manner, a lateral position of the ball 316 can be adjusted (e.g., side to side) for aligning the ball 316 with a trailer coupler. The ball 316 can be coupled to the ball mount 322 at a pivot 386. A plurality of slots 388 can extend around the pivot 386 whereby the ball 316 can lock into position. The ball 316 can swivel side to side as desired to align and couple a trailer to the ball 316 (e.g., if the trailer coupler is not already aligned with the ball 316). The ball 316 can rotate until a locking mechanism is received into the next available slot 388 in response to the towing vehicle being pulled forward.

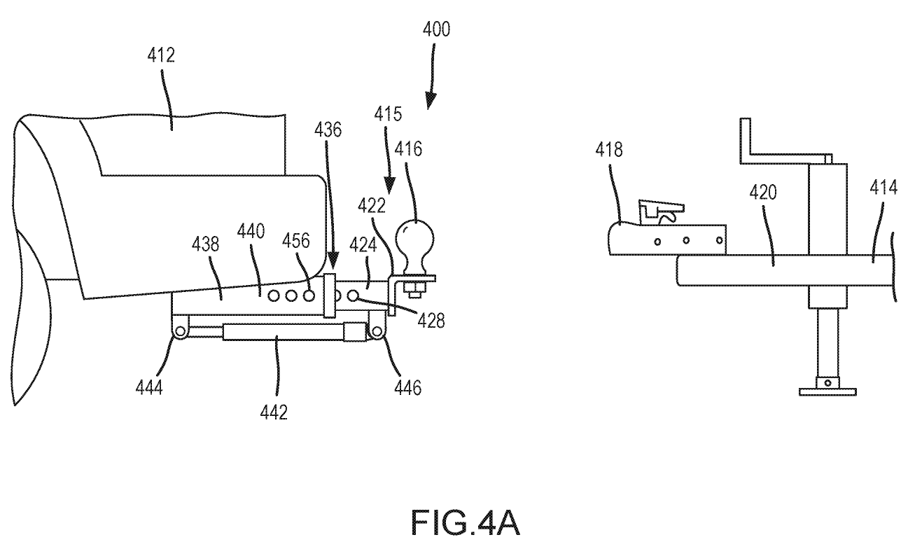

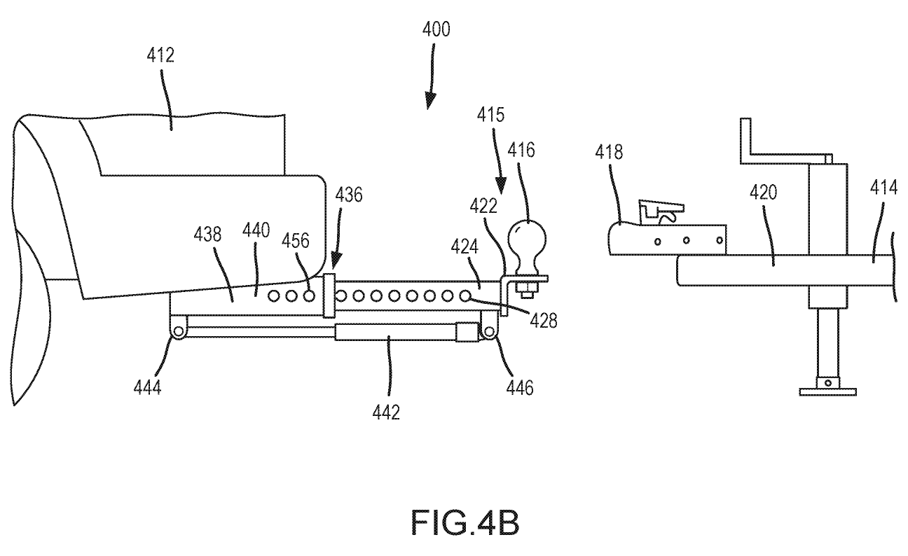

Referring now to FIG. 4A, a side view of a trailer hitch system is shown indicated generally at 400 in accordance with the principles of the present disclosure. The trailer hitch system 400 is shown in FIG. 4A on a towing vehicle 412 and a trailer 414. The towing vehicle 412 can be similar to the towing vehicle 12 of FIG. 1A. The trailer 414 can be similar to the trailer 14 of FIG. 1A.

The hitch system 400 can include a ball hitch 415 including a ball 416 for attaching to a ball socket 418 on a tongue 420 of the trailer 414. It will be understood that the hitch system 400 can be versatile, as explained more fully below, to allow the ball hitch 415 to extend and retract from the towing vehicle 412. Although described herein as a ball hitch 415, the hitch system 400 can include any suitable trailer coupling, such as a pintle hitch for example.

The ball 416 can be attached to a ball mount 422 in any suitable manner. For example, the ball 416 can be formed with a stem that may be received in the ball mount 422 and a nut may be threaded on the stem to hold the ball 416 on the ball mount 422. Accordingly, it will be understood that a ball 416 may be interchangeable, and a ball 416 of various different sizes and configurations compatible with the socket 418 can be used. It will be understood that the ball 416 can be attached to the ball mount 422 in any other suitable manner known to those skilled in the art.

A shank 424 can be joined to the ball mount 422 for attaching the ball mount 422 to a receiver 436 (sometimes referred to herein as a sleeve) of the tow vehicle 412. In this regard, the hitch system 400 can be similar to the hitch system 10 of FIG. 1A, except that the shank 424 of the hitch system 400 can be telescopingly received directly into the receiver 436 (instead of a separate sleeve, for example). The shank 424 can be a telescoping shank configured to extend from, and retract into, the receiver 436.

A first end of the shank 424 can be received into the receiver 436 and a second end of the shank 424 can be attached to the ball mount 422. The receiver 436 can form an elongate member extending in a direction transverse to the ball 416. The receiver 436 can form an elongate hollow member such as a square tube, a rectangular tube, or the like. The shank 424 can form an elongate member extending substantially parallel to the receiver 436. The elongate member can define a central axis that may extend in a direction between the trailer 414 and the tow vehicle 412. The shank 424 can be positioned concentric with the receiver 436. The shank 424 can form an elongate member such as a square tube, a square rod, or the like. In this regard the shank 424 can be solid or can be hollow, in accordance with various examples.

The receiver 436 can include a receptacle 438 configured for receiving the shank 424 of the ball hitch 415. The receptacle 438 can have a wall 440 forming a sleeve for receiving the shank 424. The receptacle 438 can be formed in a substantially square cross-sectional shape for receiving a correspondingly shaped portion of the shank 424. Accordingly, the receptacle 438 can be configured to circumscribe a portion of the shank 424. However, it will be understood that the receptacle 438 may have any other suitable shape, such as round, polygonal, rectangular, or oval, for example, corresponding to the shape of the shank 424 within the scope of the present disclosure. Moreover, in various embodiments, the receptacle 438 may only partially circumscribe the shank 424. It will also be understood that various embodiments of the receiver 436 can be a conventional receiver that can be installed on the tow vehicle 412 at the manufacturer, or as an accessory. Accordingly, the term “receiver” as used herein shall be construed broadly to include various different types of structures for receiving or joining the shank 424 with a tow vehicle 412.

In the installed position, the shank 424 is positioned at least partially in the receiver 436 of the tow vehicle 412. In various aspects, the shank 424 can be adjustably secured in position with respect to the receiver 436 through one or more shank openings 428. The openings 428 can be disposed along a length of the shank 424. It will be understood that the shank 424 can be movable with respect to the receiver 436 such that the shank openings 428 align with a desired receiver aperture 456 to position the shank 424 at the desired position. In various aspects, a locking pin (e.g., a pin, a bolt, a clip, or the like) can be positioned through a receiver aperture 456 and a corresponding shank opening 428 to secure the shank 424 at a desired position with respect to the receiver 436.

The hitch system 400 can further include an actuator 442 coupled between the receiver 436 and the ball hitch 415. For example, a first coupler 444 can extend from the wall 440 of the receiver 436. A first end of the actuator 442 can be coupled to the first coupler 444. A second coupler 446 can extend from the ball hitch 415. The second coupler 446 can extend from the shank 424 and/or the ball mount 422. A second end of the actuator 442 can be coupled to the second coupler 446. The first coupler 444 and/or the second coupler 446 can include a flange or a pair of flanges whereby the actuator 442 is connected to the receiver 436 and/or the ball hitch 415, respectively. The actuator 442 can be similar to the actuator 42 of FIG. 1A.

FIG. 4B shows a side view of the trailer hitch system 400 installed onto the towing vehicle 412 with the ball hitch 415 moved to an extended position with respect to the receiver 436. The actuator 442 can be operated to move the ball hitch 415 between the extended position (see FIG. 4B) and a retracted position (see FIG. 4A) with respect to the receiver 436. For example, the actuator 442 can extend to cause the ball hitch 415 to slidingly extend from the receiver 436 toward the extended position. Conversely, the actuator 442 can retract to cause the ball hitch 415 to slidingly retract into the receiver 436 toward the retracted position.

In this manner, the ball hitch 415 can be extended from the towing vehicle 412 for connecting the ball 416 (or any other towing mechanism) to a towed vehicle (e.g., the trailer 414). In this manner, the trailer hitch system 400 can be utilized to assist in coupling the ball 416 to the ball socket 418 without having to move the towing vehicle 412 or the trailer 414. Moreover, the trailer hitch system 400 can be operated to extend or retract while the trailer 414 is coupled to the ball hitch 415, for example for fine-tuning a position of the trailer 414. As an example, a watercraft trailer can be caused to extend from the vehicle 412 while launching or trailering a watercraft without having to move the towing vehicle 412 to fine-tune a position of the trailer in a body of water. As another example, a position of a hitched trailer can be fine-tuned in a parking space using the trailer hitch system 400.

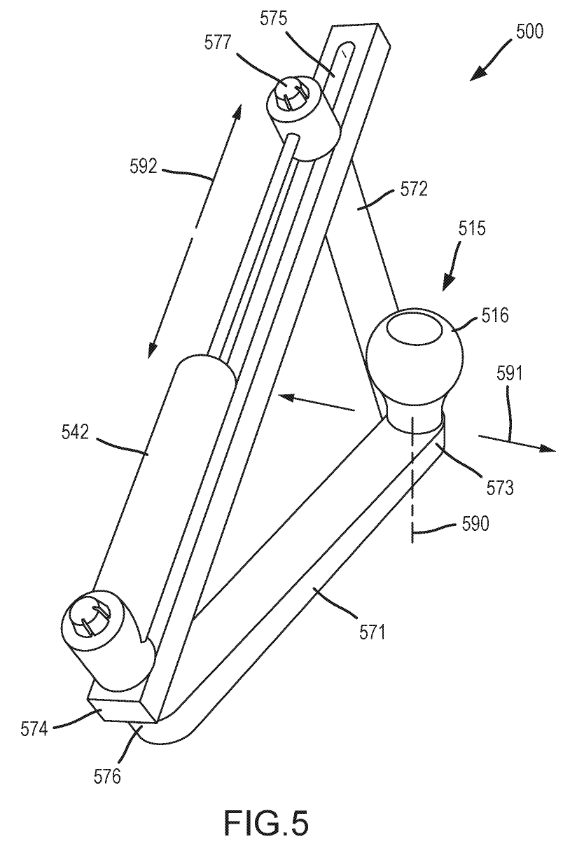

Referring now to FIG. 5, a perspective view of a trailer hitch system is shown indicated generally at 500 in accordance with the principles of the present disclosure. In various aspects, the trailer hitch system 500 can be similar to the trailer hitch system 10 of FIG. 1A, except the ball hitch 515 is coupled to the actuator 542 via a pair of linkages (i.e., a first link 571 and a second link 572).

The hitch system 500 can include a ball hitch 515 including a ball 516 for attaching to a ball socket on a tongue of a trailer (e.g., see trailer 14 of FIG. 1A). It will be understood that the hitch system 500 is versatile, as explained more fully below, to allow the ball hitch 515 to extend and retract from a towing vehicle along a first direction, indicated by arrows 591. In various aspects, the first direction 591 can be a vehicle longitudinal direction (i.e., a rear-front/font-rear direction of the vehicle). Although described herein as a ball hitch 515, the hitch system 500 can include any suitable trailer coupling, such as a pintle hitch for example.

The first link 571 can be pivotally coupled to the second link 572 at a first pivot point 573. The first link 571 and the second link 572 can be configured to rotate about an axis 590 of the first pivot point 573. In various aspects, the first pivot axis 590 is oriented substantially perpendicular to the first direction 591. The first pivot axis 590 can be a floating axis (i.e., movable with respect to the elongate beam 574). The ball 516 can be coupled to the first and second links 571, 572 at the first pivot point 573 in any suitable manner.

The hitch system 500 can further include an elongate beam 574 upon which the first and second links 571, 572 are pivotally coupled. The elongate beam 574 can include a channel or slot 575 extending along a length of the beam 574. In various aspects, the slot 575 can extend lengthwise along a second direction, indicated by arrows 592. In various aspects, the second direction 592 can be substantially perpendicular to the first direction 591. The first link 571 can be pivotally coupled to the beam 574 at a second pivot point 576. The first link 571 can be pivotally coupled to the beam 574 at a second pivot point 576. The first link 571 can be configured to rotate about an axis of the second pivot point 576. In various aspects, the second pivot axis is oriented substantially perpendicular to the first direction 591. In various aspects, the second pivot axis is oriented substantially parallel to the first pivot axis 590. The second pivot axis can be a fixed axis (i.e., fixed with respect to the elongate beam 574).

The second link 572 can be pivotally coupled to the beam 574 at the slot 575. The slot 575 can extend lengthwise along the beam 574. The slot 575 can be spaced apart from the first side of the beam 574. The second link 572 can be pivotally coupled to the beam 574 at a third pivot point 577. The second link 572 can be configured to rotate about an axis of the third pivot point 577. In various aspects, the third pivot axis is oriented substantially perpendicular to the first direction 591. In various aspects, the third pivot axis is oriented substantially parallel to the first pivot axis 590. The third pivot axis can be a floating axis (i.e., movable with respect to the elongate beam 574). The third pivot point 577 can be slidably coupled to the beam 574 via the slot 575. Stated differently, the third pivot point 577 can move back and forth along the slot 575 as the actuator 542 extends and/or retracts.

A first end of the actuator 542 can be coupled to the beam 574. A second end of the actuator 542 can be coupled to the second end of the second link 572 via the slot 575. In this regard, the second end of the actuator 542 can be pivotally coupled to the second end of the second link 572. As the actuator extends along the second direction 592, the second end of the second link 572 is driven to move away from the second end of the first link 571 along the slot 575. Driving the second end of the second link 572 away from the second end of the first link 571 along the slot 575 can cause the links 571, 572 to rotate away from one another about the first pivot axis 590 and move (e.g., pull) the ball hitch 515 toward the beam 574. As the actuator retracts along the second direction 592, the second end of the second link 572 is driven toward the second end of the first link 571 along the slot 575. Driving the second end of the second link 572 toward the second end of the first link 571 along the slot 575 can cause the links 571, 572 to rotate toward one another about the first pivot axis 590 and move (e.g., push) the ball hitch 515 away from the beam 574.

In various aspects, the beam 574 can be similar to the frame 380 of FIG. 3A. In this regard, the beam 574 can extend laterally between opposing sides (e.g., a driver side and a passenger side) of the vehicle. Stated differently, the second direction 592 can extend substantially parallel to a vehicle lateral direction. In this regard, the first direction 591 can be a vehicle longitudinal direction.

Having described various aspects of the hitch system 500, a method for operating the hitch system 500 can include operating the actuator 542 to move from a first position (e.g., an extended position) to a second position (e.g., a retracted position). The method can further include moving the ball hitch 515 with respect to the beam 574 with the actuator 542 in response to the actuator 542 moving from the first position to the second position. The ball hitch 515 can move in an aft direction away from a towing vehicle in response to the ball hitch 515 moving with respect to the beam 574. The actuator 542 can be operated to move from the second position back to the first position to move the ball hitch 515 in a forward direction toward the towing vehicle.

As used herein, “substantially parallel” and “substantially perpendicular” means within plus or minus 5 or 10 or 15 percent from parallel and perpendicular, respectively, in accordance with various examples.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “various aspects,” “one aspect,” “an aspect,” “an example aspect,” “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A hitch system, comprising:
a ball hitch including a ball mount and a shank;
a sleeve configured to receive at least a portion of the shank, the sleeve is configured to be mounted to a towing vehicle; and
an actuator coupled between the sleeve and the ball hitch, wherein the actuator is configured to cause the ball hitch to move between an extended position with respect to the sleeve and a retracted position with respect to the sleeve.

2. The hitch system of claim 1, wherein the shank comprises a shank aperture and the sleeve comprises a sleeve aperture, and the shank aperture is configured to align with the sleeve aperture to receive a locking pin therethrough for locking the ball hitch to the sleeve.

3. The hitch system of claim 1, further comprising a hitch mount coupled to the sleeve, whereby the sleeve is configured to be mounted to the towing vehicle.

4. The hitch system of claim 3, wherein the hitch mount comprises an elongated square tube.

5. The hitch system of claim 3, further comprising a connecting member extending between and to the hitch mount whereby the sleeve is secured to the hitch mount.

6. The hitch system of claim 4, further comprising a clamp member configured to be coupled around the sleeve and the hitch mount for supporting the sleeve relative to the hitch mount.

7. The hitch system of claim 1, further comprising a first flange extending from the sleeve and a second flange extending from the ball hitch, and the actuator extends between and to the first flange and the second flange, and the actuator is a linear actuator.

8. The hitch system of claim 1, wherein the shank comprises a plurality of shank apertures and the sleeve comprises a sleeve aperture, and the sleeve aperture is configured to align with each shank aperture of the plurality of shank apertures depending on a position of the ball hitch with respect to the sleeve.

9. The hitch system of claim 1, wherein the sleeve comprises a plurality of sleeve apertures and the shank comprises a shank aperture, and the shank aperture is configured to align with each sleeve aperture of the plurality of sleeve apertures depending on a position of the ball hitch with respect to the sleeve.

10. A vehicle, comprising:
a hitch receiver;
a ball hitch including a ball mount and a shank;
an actuator coupled between the hitch receiver and the ball hitch, wherein the actuator is configured to cause the ball hitch to move between an extended position with respect to the hitch receiver and a retracted position with respect to the hitch receiver.

11. The vehicle of claim 10, further comprising a sleeve configured to receive at least a portion of the shank, the sleeve is configured to be mounted to the hitch receiver.

12. The vehicle of claim 11, wherein the shank comprises a shank aperture and the sleeve comprises a sleeve aperture, and the shank aperture is configured to align with the sleeve aperture to receive a locking pin therethrough for locking the ball hitch to the sleeve.

13. The vehicle of claim 11, further comprising a hitch mount coupled to the sleeve, the hitch mount is configured to be received in the hitch receiver for mounting the sleeve to the vehicle.

14. The vehicle of claim 13, further comprising a connecting member extending between and to the hitch mount whereby the sleeve is secured to the hitch mount.

15. The vehicle of claim 14, further comprising a clamp member configured to be coupled around the sleeve and the hitch mount for supporting the sleeve relative to the hitch mount.

16. The vehicle of claim 14, wherein the sleeve is disposed beneath the hitch receiver.

17. The vehicle of claim 14, further comprising a chain aperture disposed in the connecting member, the connecting member is configured to be connected to a safety chain of a towed vehicle at the chain aperture.

18. A method for operating a hitch system, the method comprising:
operating an actuator to move from a first position to a second position; and
moving a ball hitch with the actuator in an aft direction away from a towing vehicle in response to the actuator moving from the first position to the second position.

19. The method of claim 18, further comprising:
operating the actuator to move from the second position to the first position; and
moving the ball hitch with the actuator in response to the actuator moving from the second position to the first position, wherein the ball hitch moves in a forward direction toward the towing vehicle in response to the ball hitch moving.

20. The method of claim 18, further comprising moving a locking pin to extend through a shank aperture of a shank of the ball hitch for locking the ball hitch in position.
